(19) United States
(12) Patent Application Publication
(10) Pub. No.: US 2005/0008201 A1
(43) Pub. Date: Jan. 13, 2005

(54) Iris identification system and method, and storage media having program thereof

(76) Inventors: Yill-Byung Lee, Seoul (KR); Kwan-Young Lee, Seoul (KR); Kyung-Do Kee, Seoul (KR); Sung-Soo Yoon, Kyungki-do (KR)

Correspondence Address: Thomas M Galgano;Galgano & Burke, Suite 135, 300 Rabro Drive, Hauppauge, NY, 11788, US

(21) Appl. No.: 10/495,960

(22) PCT Filed: Dec. 3, 2002
(86) PCT No.: PCT/KR02/02271

(30) Foreign Application Priority Data
Dec. 3, 2001 (KR) 2001-0075967

(51) Int. Cl. G06K 9/00

(52) U.S. Cl. 382/117

(57) ABSTRACT

Disclosed is an iris identification system and method, and storage media having program thereof. The iris identification system comprising a characteristic vector database (DB) for pre-storing characteristic vectors to identify persons; an iris image extractor for extracting an iris image in the eye image inputted from the outside; a characteristic vector extractor for multi-dividing the iris image extracted by the iris image extractor, obtaining a iris characteristic region from the multi-divided each iris image, and extracting a characteristic vector from the iris characteristic region by a statistical method; and a recognizer for comparing the characteristic vector DB thereby identifying a person.

### TECHNICAL FIELD

The present invention relates to an iris identification system and method, and a storage media having program thereof, capable of minimizing an identification error by multi-dividing an iris image and effectively extracting a characteristic region from the iris image.

### BACKGROUND ART

In general, edge detecting method is used to separate an iris region between pupil and sclera. However it takes a long time for detecting the iris in case that a circle component is not present in an eye image because it is practiced under an assumption that the circle component is present in the eye image.

Also it has a problem that only a portion of pupil may be included in the eye image or a portion of the iris may be lost according to the shape of a hypothetical circle because the iris region is determined by the hypothetical circle using a center of pupil. The hypothetical circle has a size and a position similar to those of pupil.

Also there is a method for extracting a characteristic of the iris and constructing a characteristic vector using Gover transform, the characteristic vector is constructed over 256 dimension. However it has a problem in efficiency because there are used at least 256 bytes under assumption that one dimension occupies 1 byte.

Also, there is a method for measuring a distance such as Hamming distance to compare the iris characteristic vector. However it has problems that it is not easy to construct reference characteristic vector through generalization of iris pattern, and to appropriately reflect the feature included in each dimension of characteristic vectors.

Also, there are some problems in process time and identification rate because the conventional iris identification system has not function determining whether the image inputted from the outside is appropriate or not for an iris identification. Accordingly it is not convenient in that user have to correctly select his position.

### DISCLOSURE OF THE INVENTION

Therefore, the present invention has been made in view of the above-mentioned problems, and it is an object of the present invention to provide an iris identification system and method, and a storage media having program thereof, capable of extracting an iris image without losing information by using Canny edge detector, Bisection method and Elastic body model.

It is another object of the present invention to provide an iris identification system and method, and a storage media having program thereof, capable of effectively extracting characteristic areas in low and high frequency bands of the iris image, and constructing a characteristic vector from statistic values of the extracted characteristic regions.

It is another object of the present invention to provide an iris identification system and method, and a storage media having program thereof, capable of minimizing identification error.

It is another object of the present invention to provide an iris identification system and method, and a storage media having program thereof, capable of filtering eye image adapted for iris identification.

According to an aspect of the present invention, there is provided an iris identification system, the iris identification system comprising a characteristic vector database (DB) for pre-storing characteristic vectors to identify persons; an iris image extractor for extracting an iris image in the eye image inputted from the outside; a characteristic vector extractor for multi-dividing the iris image extracted by the iris image extractor, obtaining a iris characteristic region from the multi-divided each iris image, and extracting a characteristic vector from the iris characteristic region by a statistical method; and a recognizer for comparing the characteristic vector extracted from the characteristic vector extractor with the characteristic vector stored in the characteristic vector DB thereby identifying a person.

Preferably, the iris image extractor comprises an edge element detecting section for detecting edge element by applying Canny edge detection method to the eye image; a grouping section for grouping the detected edge element; an iris image extracting section for extracting the iris image by applying Bisection method to the grouped edge element; and a normalizing section for normalizing the extracted iris image by applying elastic body model to the extracted iris image.

Preferably, the elastic body model comprises a plurality of elastic bodies, each elastic body is extendible in a longitudinal direction, and has one end connected to sclera and the other end connected to pupil.

Preferably, the characteristic vector extractor comprises a multi-dividing section for wavelet-packet transforming the iris image extracted by the iris image extractor to multi-divide the extracted iris image; a calculating section for calculating energy values for regions of the multi-divided iris images; a characteristic region extracting section for extracting and storing the region that has energy value more than a predetermined reference value from the regions of the multi-divided iris images; and a characteristic vector constructing section for dividing the extracted and stored region into sub-regions, obtaining average value and standard deviation value for the sub-regions, and constructing a characteristic vector by using the average value and the standard deviation value; for the region extracted from the characteristic region extracting section, the wavelet-packet transform process by the multi-dividing section and the energy value calculating process by the calculating section are repeatedly executed in a determined number, and then the regions having energy value more than the reference value are stored in the characteristic region extracting section.

Preferably, the calculating section squares the each energy value of the multi-divided region, adds the squared energy values, and divides the added energy value by number of the region thereby capable of obtaining the resultant energy value.

Preferably, the recognizer calculates the distance between characteristic vectors by applying Support vector machine method to the characteristic vector extracted from the characteristic vector extracting section and the characteristic vector pre-stored in the characteristic vector DB, and confirm the identity for a person if the calculated distance between the characteristic vectors is smaller than the predetermined reference value.

Preferably, the characteristic vector extractor comprises a multi-dividing section for multi-dividing the iris image extracted from the iris image extractor by applying Daubechies wavelet transform to the extracted iris image, and extracting the region including the high frequency component HH for x-axis and y-axis from the multi-divided iris image; a calculating section for calculating discrimination rate D of the iris pattern by the characteristic value of the HH region, and increments repeat number; a characteristic region extracting section for determining whether the predetermined reference value is smaller than the discrimination rate D or the repeat number is smaller than the predetermined reference number, completing operation thereof if the reference value is larger than the discrimination rate D or the repeat number is larger than the reference number, storing and administrating the information of HH region if the reference value is equal to or smaller than the discrimination rate D, or the repeat number is equal to or smaller than the reference number, extracting the region LL that has low frequency component for the x-axis and y-axis, selecting the LL region as a new process object image; and a characteristic vector constructing section for dividing the extracted and stored region into sub-regions, obtaining average value and standard deviation value for the sub-regions, and constructing a characteristic vector by using the average value and the standard deviation value; for the region selected as the new process object image by the characteristic region extracting section, the multi-dividing process by the multi-dividing section and the processes thereafter are repeatedly executed.

Preferably, the discrimination rate D is the value obtained by squaring value of the each pixel of HH region, adding the squared values, and dividing the added value by total number of the HH region.

Preferably, the recognizer confirms the identity for a person by applying the normalized Euclidian distance and Minimum distance classification rule to the characteristic vector extracted from the characteristic vector extractor and the characteristic vector pre-stored in the characteristic vector DB.

Preferably, the system further comprises a filter for filtering the eye image inputted from the outside, and outputting it to the iris image extractor.

Preferably, the filter comprises a blinking detecting section for detecting a blinking of the eye image; a pupil position detecting section for the position of the pupil in the eye image; a vertical component detecting section for detecting the vertical component of the edge; a filtering section for excluding the eye images that the values obtained by multiplying values detected respectively by the blinking detecting section, the pupil position detector and the vertical component detector by the weighed values W1, W2, and W3 respectively is more than a predetermined reference value, and outputting the remaining eye image to the iris image extractor.

Preferably, when the eye image is divided into M×N blocks, the blinking detecting means calculates sum of average brightness of blocks in a raw, and outputs the brightest value F1.

Preferably, the weighted value W1 is weighted in proportion to the distance from the vertical center of the eye image.

Preferably, when the eye image is divided into M×N blocks, the pupil position detecting section detects the block F2 that the average brightness of each block is smaller than the predetermined value.

Preferably, the weighted value W2 is weighted in proportional to the distance from the center of the eye image.

Preferably, the vertical component detecting section detects the value F3 of the vertical component of the iris region by Sobel edge detection method.

Preferably, the weighted value W3 is the same regardless of the distance from the center of the eye image.

Preferably, the system further comprises a register to record the characteristic vector extracted from the characteristic vector extractor in the characteristic vector DB.

Preferably, the system further comprises a photographing means to take an eye image of a person and to output it to the filter.

According to another aspect of the present invention, there is provided an iris identification method, the iris identification method comprising the steps of extracting an iris image in the eye image inputted from the outside; multi-dividing the extracted iris image, obtaining a iris characteristic region from the multi-divided each iris image, and extracting a characteristic vector from the iris characteristic region by a statistical method; and comparing the extracted characteristic vector with the characteristic vector stored in the characteristic vector DB thereby identifying a person.

Preferably, the step of extracting the iris image comprises the sub-steps of (a1) detecting edge element by applying Canny edge detection method to the eye image; (a2) grouping the detected edge element; (a3) extracting the iris image by applying Bisection method to the grouped edge element; and (a4) normalizing the extracted iris image by applying elastic body model to the extracted iris image.

Preferably, the elastic body model comprises a plurality of elastic bodies, each elastic body is extendible in a longitudinal direction, and has one end connected to sclera and the other end connected to pupil.

Preferably, the step of extracting the characteristic vector comprises the sub-steps of (b1) wavelet-packet transforming the iris image extracted by the step (a) to multi-divide the extracted iris image; (b2) calculating energy values for regions of the multi-divided iris images; (b3) extracting and storing the region that has energy value more than a predetermined reference value from the regions of the multi-divided iris images, and the wavelet-packet transform step to the energy value calculating step are repeatedly executed for the extracted region; and (b4) dividing the extracted and stored region into sub-regions, obtaining average value and standard deviation value for the sub-regions, and constructing a characteristic vector by using the average value and the standard deviation value.

Preferably, the energy value is the value obtained by squaring energy values of the multi-divided region, adds the squared energy values, and divides the added energy value by total number of the region.

Preferably, the step of identifying a person comprises the steps of calculating the distance between characteristic vectors by applying Support vector machine method to the extracted characteristic vector and the pre-stored characteristic vector, and confirming the identity for a person if the calculated distance between the characteristic vectors is smaller than the predetermined reference value.

Preferably, the step of extracting the characteristic vector comprises the sub-steps of (b1) multi-dividing the iris image extracted from the iris image extractor by applying Daubechies wavelet transform to the extracted iris image; (b2) extracting the HH region including the high frequency component for x-axis and y-axis from the multi-divided iris image; (b3) calculating discrimination rate D of the iris pattern by the characteristic value of the HH region, and incrementing repeat number; (b4) determining whether the predetermined reference value is smaller than the discrimination rate D or the repeat number is smaller than the predetermined reference number; (b5) completing operation thereof if the reference value is larger than the discrimination rate D or the repeat number is larger than the reference number, and storing and administrating the information of HH region if the reference value is equal to or smaller than the discrimination rate D, or the repeat number is equal to or smaller than the reference number; (b6) extracting the LL region including low frequency component for the x-axis and y-axis; (b7) selecting the LL region as a new process object image wherein the multi-dividing step and the steps thereafter are repeatedly executed for the region selected as the new process object image; and (b8) dividing the extracted and stored region into sub-regions, obtaining average value and standard deviation value for the sub-regions, and constructing a characteristic vector by using the average value and the standard deviation value.

Preferably, the discrimination rate D is the value obtained by squaring value of the each pixel of HH region, adding the squared values, and dividing the added value by total number of the HH region.

Preferably, the step of identifying a person comprises the step of confirming the identity for a person by applying the normalized Euclidian distance and Minimum distance classification rule to the extracted characteristic vector and the pre-stored characteristic vector.

Preferably, the method further comprises the step of filtering the eye image inputted from the outside.

Preferably, the filtering step comprises the sub-steps of (c1) detecting a blinking of the eye image; (c2) detecting the position of the pupil in the eye image; (c3) detecting the vertical component of the edge; (c4) excluding the eye images that the values obtained by multiplying values detected respectively by the blinking detecting, the pupil position detecting and the vertical component detecting steps by the weighed values W1, W2, and W3 respectively is more than a predetermined reference value, and using the remaining eye image.

Preferably, the step (c1) comprises the sub-steps of, when the eye image is divided into M×N blocks, calculating sum of average brightness of blocks in each raw, and outputting the brightest value F1.

Preferably, the weighted value W1 is weighted in proportion to the distance from the vertical center of the eye image.

Preferably, the step (c2) comprises the sub-step of, when the eye image is divided into M×N blocks, detecting the block F2 that the average brightness of each block is smaller than the predetermined value.

Preferably, the weighted value W2 is weighted in proportional to the distance from the center of the eye image.

Preferably, the step (c3) detects the value F3 of the vertical component of the iris region by Sobel edge detection method.

Preferably, the weighted value W3 is the same regardless of the distance from the center of the eye image.

Preferably, the method further comprises the step of recording the extracted characteristic vector.

According to another aspect of the present invention, there is provided a computer-readable storage medium on which a program is stored, the program including the processes of extracting an iris image in the eye image inputted from the outside; multi-dividing the extracted iris image, obtaining a iris characteristic region from the multi-divided each iris image, and extracting a characteristic vector from the iris characteristic region by a statistical method; and comparing the extracted characteristic vector with the characteristic vector stored in the characteristic vector DB thereby identifying a person.

Preferably, the process of extracting the iris image comprises the sub-processes of (a1) detecting edge element by applying Canny edge detection method to the eye image; (a2) grouping the detected edge element; (a3) extracting the iris image by applying Bisection method to the grouped edge element; and (a4) normalizing the extracted iris image by applying elastic body model to the extracted iris image.

Preferably, the elastic body model comprises a plurality of elastic bodies, each elastic body is extendible in a longitudinal direction, and has one end connected to sclera and the other end connected to pupil.

Preferably, the process of the characteristic vector comprises the sub-processes of (b1) wavelet-packet transforming the iris image extracted by the process of extracting the iris image to multi-divide the extracted iris image; (b2) calculating energy values for regions of the multi-divided iris images; (b3) extracting and storing the region that has energy value more than a predetermined reference value from the regions of the multi-divided iris images, and the wavelet-packet transform process to the energy value calculating process are repeatedly executed for the extracted region; and (b4) dividing the extracted and stored region into sub-regions, obtaining average value and standard deviation value for the sub-regions, and constructing a characteristic vector by using the average value and the standard deviation value.

Preferably, the energy value is the value obtained by squaring energy values of the multi-divided region, adds the squared energy values, and divides the added energy value by total number of the region.

Preferably, the process of identifying a person comprises the sub-processes of calculating the distance between characteristic vectors by applying Support vector machine method to the extracted characteristic vector and the pre-stored characteristic vector, and confirming the identity for a person if the calculated distance between the characteristic vectors is smaller than the predetermined reference value.

Preferably, the process of extracting the characteristic vector comprises the sub-processes of (b1) multi-dividing the iris image extracted from the iris image extractor by applying Daubechies wavelet transform to the extracted iris image; (b2) extracting the HH region including the high frequency component for x-axis and y-axis from the multi-divided iris image; (b3) calculating discrimination rate D of the iris pattern by the characteristic value of the HH region, and incrementing repeat number; (b4) determining whether the predetermined reference value is smaller than the discrimination rate D or the repeat number is smaller than the predetermined reference number; (b5) completing operation thereof if the reference value is larger than the discrimination rate D or the repeat number is larger than the reference number, and storing and administrating the information of HH region if the reference value is equal to or smaller than the discrimination rate D, or the repeat number is equal to or smaller than the reference number; (b6) extracting the LL region including low frequency component for the x-axis and y-axis; (b7) selecting the LL region as a new process object image wherein the multi-dividing process and the processes thereafter are repeatedly executed for the region selected as the new process object image; and (b8)dividing the extracted and stored region into sub-regions, obtaining average value and standard deviation value for the sub-regions, and constructing a characteristic vector by using the average value and the standard deviation value.

Preferably, the discrimination rate D is the value obtained by squaring value of the each pixel of HH region, adding the squared values, and dividing the added value by total number of the HH region.

Preferably, the process of identifying a person comprises the process of confirming the identity for a person by applying the normalized Euclidian distance and Minimum distance classification rule to the extracted characteristic vector and the pre-stored characteristic vector.

Preferably, the program further comprises the process of filtering the eye image inputted from the outside.

Preferably, the filtering process comprises the sub-processes of (c1) detecting a blinking of the eye image; (c2) detecting the position of the pupil in the eye image; (c3) detecting the vertical component of the edge; (c4) excluding the eye images that the values obtained by multiplying values detected respectively by the blinking detecting process, the pupil position detecting process and the vertical component detecting process by the weighed values W1, W2, and W3 respectively is more than a predetermined reference value, and using the remaining eye image.

Preferably, the process (c1) comprises the sub-processes of, when the eye image is divided into M×N blocks, calculating sum of average brightness of blocks in each raw, and outputting the brightest value F1.

Preferably, the weighted value W1 is weighted in proportion to the distance from the vertical center of the eye image.

Preferably, the process (c2) comprises the sub-process of, when the eye image is divided into M×N blocks, detecting the block F2 that the average brightness of each block is smaller than the predetermined value.

Preferably, the weighted value W2 is weighted in proportional to the distance from the center of the eye image.

Preferably, the process (c3) detects the value F3 of the vertical component of the iris region by Sobel edge detection method.

Preferably, the weighted value W3 is the same regardless of the distance from the center of the eye image.

Preferably, the program further comprises the process of recording the extracted characteristic vector.

### BRIEF DESCRIPTION OF THE DRAWINGS

The foregoing and other objects, features and advantages of the present invention will become more apparent from the following detailed description when taken in conjunction with the accompanying drawings in which:

FIG. 1a is a block diagram of an iris identification system using wavelet packet transform according to the present invention;

FIG. 1b is a block diagram of an iris identification system further comprising a register in construction of FIG. 1;

FIG. 2a is a block diagram of an iris image extractor according to an embodiment of the present invention;

FIG. 2b is a view of explaining a method for extracting an iris by a Bisection method;

FIG. 2c is a view of Elastic body model applied to the iris image;

FIG. 3a is a block diagram of a characteristic vector extractor according to the present invention.

FIG. 3b is a view of explaining an iris characteristic region;

FIG. 4a is a block diagram of an iris identification system further comprising filter in construction of FIG. 1;

FIG. 4b is a block diagram of a filter according to an embodiment of the present invention;

FIG. 5 is a flow chart of an iris identification method executed by using wavelet packet transform method;

FIG. 6 is a detailed flow chart of illustrating an iris image extracting process;

FIG. 7 is a detailed flow chart of illustrating a characteristic vector extracting process;

FIG. 8 is a flow chart of illustrating a image filtering process; and

FIG. 9 is a flow chart of illustrating an iris identification method by Daubechies wavelet packet transform.

### BEST MODE FOR CARRYING OUT THE INVENTION

Reference will now be made in detail to the preferred embodiments of the present invention.

FIG. 1a is a block diagram of an iris identification system using wavelet packet transform according to the present invention.

Referring to FIG. 1, the iris identification system comprises an iris image extractor 10, a characteristic vector extractor 20, a recognizer 30 and a characteristic vector DB 40.

The iris image extractor 10 extracts an iris image in an eye image inputted from the outside.

The characteristic vector extractor 20 wavelet packet transforms the iris image extracted from the iris image extractor 10, multi-divides the transformed image, obtains an iris characteristic region from the multi-divided images, and extracts a characteristic vector by using a statistical method.

The recognizer 30 identifies a person by comparing the characteristic vector extracted from the characteristic vector extractor 20 with the characteristic vector stored in the characteristic vector DB 40. The characteristic vector DB 40 includes pre-stored characteristic vectors corresponding to each person.

Also, the recognizer 30 calculates the distance between the characteristic vectors by applying Support vector machine method to the characteristic vector extracted from the characteristic vector extractor 20 and the characteristic vector stored in the characteristic vector DB 40.

Also, the recognizer 30 outputs the recognition result as the same person when the value of the calculated distance is smaller than a predetermined reference value, and outputs the recognition result as the different person when the value of the calculated distance is equal to or larger than the predetermined reference value.

The reason why Support vector machine method is used is capable of improving identification degree and accuracy of characteristic vector groups generated by wavelet packet transform method.

FIG. 1b is a block diagram of an iris identification system further comprising a register in construction of FIG. 1a. The register 50 records the characteristic vector extracted by the characteristic vector extractor 20 in the characteristic vector DB 40.

The iris identification system according to the present invention further comprises a photographing means for photographing an eye of a person and outputting it to the iris image extractor 10.

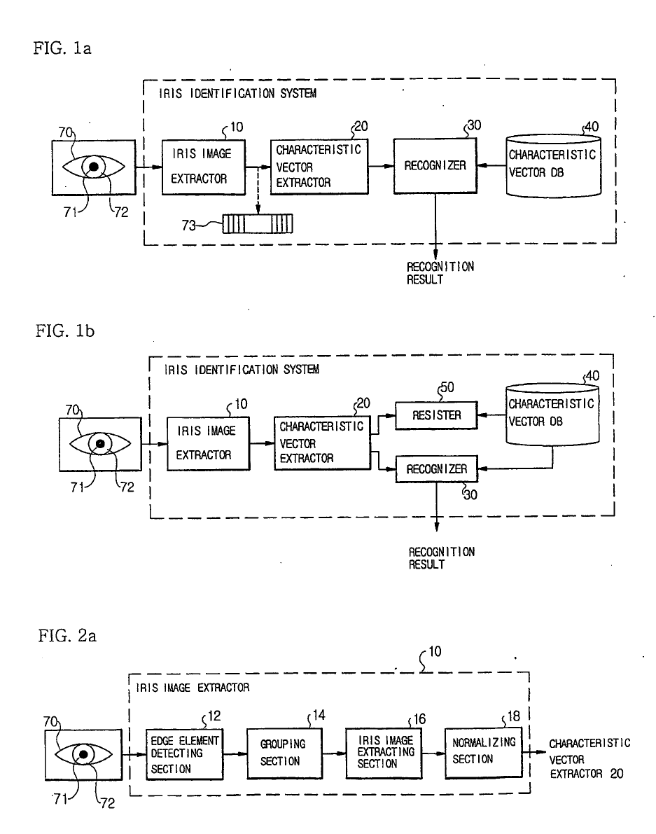

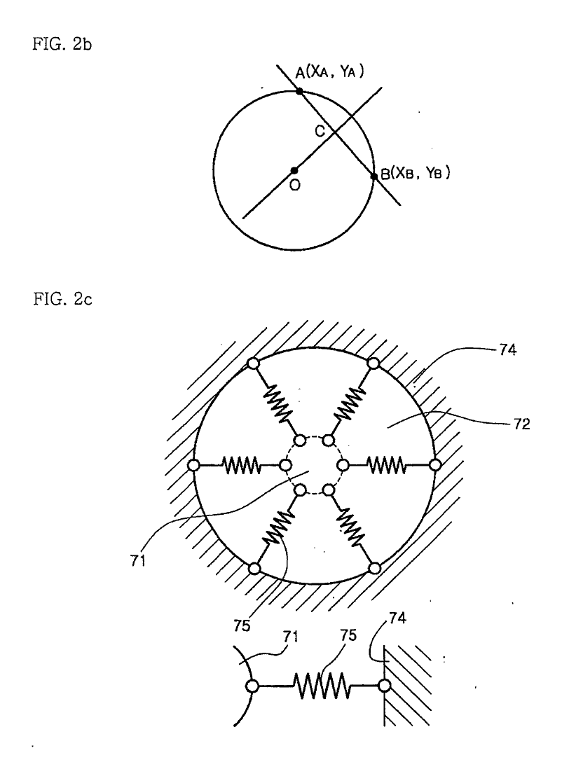

FIG. 2a is a block diagram of an iris image extractor according to an embodiment of the present invention.

Referring to FIG. 2a, the iris image extractor 10 comprises an edge element detecting section 12, a grouping section 14, an iris image extracting section 16 and normalizing section 18.

The edge element detecting section 12 detects edge elements using Canny edge detector. At this time, the edge element of iris 72(FIG. 2c) and sclera 74(FIG. 2c) is well extracted because there are many differences between foreground and background of eye image. However edge element of iris 72 and pupil 71 (FIG. 2c) is not well extracted because there are hardly differences in background thereof.

Accordingly the grouping section 14 and the iris image extracting section 16 are used to accurately find the edge element of iris 72 and pupil 71 and the edge element of sclera 74 and iris 72.

The grouping section 14 groups edge elements detected by the edge element detecting section 12. Table (a) shows edge elements extracted from the edge element detecting section 12, and table (b) shows a result grouping edge elements of table (a).

| | | | | | |
|---|---|---|---|---|---|
| 1 | 1 | 0 | A | A | |
| 0 | 0 | 0 | | | |
| 1 | 1 | 1 | B | B | B |

| | |
|---|---|
| (a) | (b) |

The grouping section 14 groups linked pixel edge elements as a group. Herein grouping includes arranging the edge elements according to the linked order.

FIG. 2b is a view of explaining a method for extracting an iris by applying Bisection method to the grouped edge elements.

Referring to FIG. 2b, the iris image extracting section 16 regards the grouped edge elements as one dege group; and applies Bisection method to each group thereby capable of obtaining the center of circle. As shown FIG. 2b, the iris image extracting section 16 obtains the bisectrix C perpendicular to straight line connecting arbitrary two points A (X_{A}, Y_{A}) and B (X_{B}, Y_{B}), and verifies whether the obtained straight line approach to the center O of the circle.

As a result, the iris image extracting section 16 determines the edge group positioned inside of borderline among edge groups having high proximity as inner edge element the iris, and determines the edge group positioned outside of borderline among edge group having high proximity as outer edge element of the iris.

The iris image extracted from the iris image extracting section 16 is normalized by application of the Elastic body model in the normalizing section 18. FIG. 2c is a view of Elastic body model used in normalizing the iris image.

The reason why Elastic body model is used is that it is necessary to map the iris image defined by pupil 71 and sclera 74 into a predetermined space. The Elastic body model has to satisfy a premise condition that the region relation of the iris image should be one to one correspondence although the shape of the iris image is deformed. The elastic body model must consider the mobility generated when the shape of the iris image is deformed.

The elastic body model includes a plurality of elastic body wherein each elastic body has a one end connected to the sclera 74 by a pin joint and the other end connected to the pupil 71. The elastic body may be deformed in longitudinal direction but have to be not deformed in direction perpendicular to the longitudinal direction.

Under this condition, the front end of the elastic body is rotatable because it is coupled with the pin joint. The direction perpendicular to the boundary of the pupil may be set as axis direction of the elastic body.

The iris pattern distributed in the iris image is densely distributed in the region close to the pupil 71, and is widely distributed in the region close to the sclera 74. Accordingly it is not possible to recognize the iris although minor error is occurred in the region close to the pupil 71. It is also possible to mis-recognize the iris in the region close to the sclera 74 as that of the other person.

It is also possible to occur errors due to deformation by asymmetrical constriction or expansion of the muscle of the iris. Original image may be deformed when the angle photographing the eye image is declined to the pupil.

Thus it is possible to get the normalized iris image 73 as shown in FIG. 1, when Elastic body model is applied. Hereinafter the process applying to the elastic body model is described.

The relation between internal and external boundaries is as follows;

$$To = arcsin \{ \frac{( Yi - Yoc ) * cos Ni - ( Xi - Xoc ) * sin Ni}{Ro} \} + Ni$$

Herein, (Xi, Yi): a coordinate of one point positioned inside of boundary
Ni: direction of the normal line vector at Xi and Yi (Xoc, Yoc): center of external boundary
Ro: radius of external boundary
(Xo, Yo): a position where the elastic body including Xi and Yi is connected to the external boundary by the pin joint
To: angle between (Xoc, Yoc) and (Xo, Yo)

Firstly, Ni is calculated, and then relation between Ni and To is set as above equation. Thereafter Ni and (Xi, Yi) for To are calculated while moving the angle of the polar coordinate in a predetermined angle unit on the base of circle of external boundary. And then image between (Xi, Yi) and (Xo, Yo) is normalized. The iris image obtained by such a process has a property strong to deformation due to the movement of the iris.

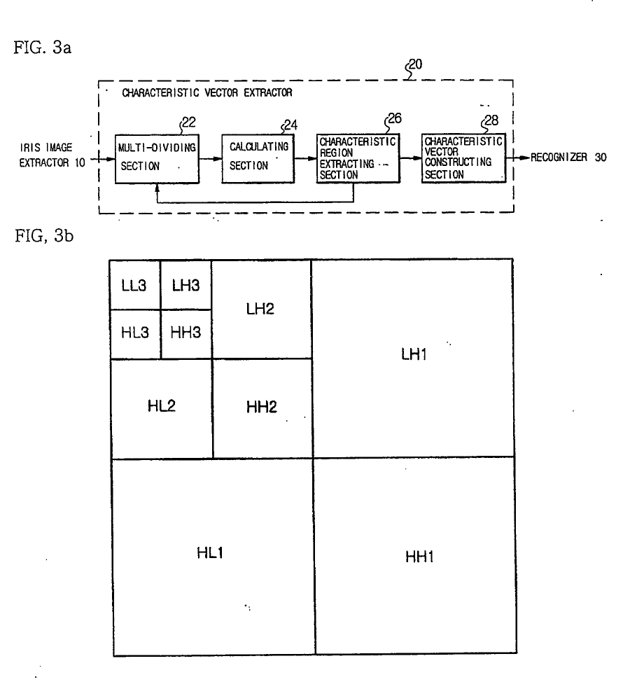

FIG. 3a is a block diagram of a characteristic vector extractor according to the present invention.

Referring to FIG. 3a, the characteristic vector extractor 20 comprises a multi-dividing section 22, a calculating section 24, a characteristic region extracting section 26 and a characteristic vector constructing section 28.

The multi-dividing section 22 wavelet-packet transforms the iris image extracted from the iris image extracting section 10. Hereinafter the wavelet-packet transform is more detailed described.

The wavelet-packet transform resolves two-dimensional iris image to have components for frequency and time. The iris image is divided into 4 regions, that is, regions including high frequency components HH, HL and LH, and region including low frequency component LL as shown in FIG. 3b whenever wavelet-packet transform is executed.

The region including the lowest frequency band represents a statistical property similar to the original image, the other bands except the lowest frequency band has a property that energy is focused into the boundary region.

Since the wavelet-packet transform provides a sufficient wavelet basement, it is possible to effectively resolve the iris image when the basement adapted for the space-frequency characteristic is appropriately selected. Accordingly, it is possible to resolve the iris image according to the space-frequency characteristic in low frequency band as well as high frequency band.

The calculating section 24 calculates energy values for each region of iris image divided by the multi-dividing section 22.

The characteristic region extracting section 26 extracts and stores the region has energy value larger than a predetermined reference value among regions of the iris image multi-divided by the multi-dividing section.

The region extracted from the characteristic region extracting section is again wavelet-packet transformed. And then the process for calculating the energy value in the calculating section 24 is repeated as a predetermined number. The region that energy value is larger than the reference value is stored in the characteristic region extracting section 26.

When the iris characteristic for the all region is extracted and the characteristic vector is constructed, recognition rate is degraded and process time is increased because the region including useless information is utilized. Accordingly since the region having a higher energy value is regarded as that including more characteristic information, only the region larger than the reference value is extracted in the characteristic region extracting section 26.

FIG. 3b shows the iris characteristic region obtained by applying the wavelet-packet transform of 3 times. Suppose that only the LL region has energy value larger than the reference value when the wavelet-packet transform is executed at 2 times and only the LL3 region and HL3 region have energy value larger than the reference value when the wavelet-packet transform is executed at 3 times. And then LL1, LL2, LL3 and HL3 regions are extracted and stored as the characteristic region of the iris image.

The characteristic vector constructing section 28 divides the region extracted and stored by the characteristic region extracting section 26 into M×N sub-regions, obtains average value and standard deviation value of each sub-region, and constructs the characteristic vector using the obtained average and standard deviation values.

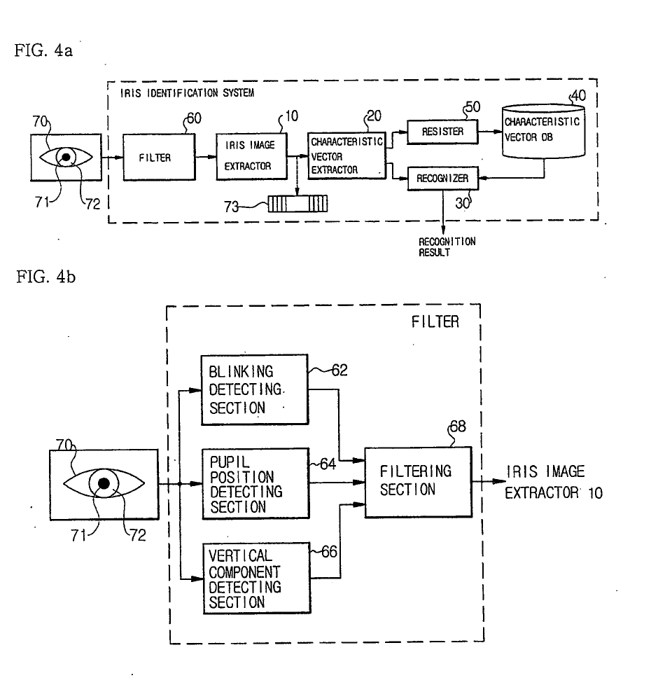

FIG. 4a is a block diagram of an iris identification system further comprising filter in construction of FIG. 1, and FIG. 4b is a block diagram of the filter according to an embodiment of the present invention.

The filter 60 filters the eye image inputted from the outside and outputs it to the iris image extracting section 10. The filter 60 comprises a blinking detecting section 62, a pupil position detecting section 64, a vertical component detecting section 66 and a filtering section 68.

The blinking detecting section 62 detects a blinking of the eye image and outputs it to the filtering section 68. When the eye image is divided into M×N blocks, the blinking detecting section 62 calculates sum of average brightness of blocks in each raw, and outputs the brightest value F1 to the filtering section 68.

The blinking detector 62 uses that the eyelid image is brighter than the iris image. This is to separate the image of bad quality since the eyelid shades the iris when the eyelid is positioned at center.

The pupil position detecting section 64 detects the position of the pupil in eye image and output it to the filtering section 68. When the eye image is divided into M×N blocks, the blinking detecting section 62 detects the block F2 having average brightness smaller than a predetermined reference value and outputs it to the filtering section 68. It is possible to easily detect the block F2 when the vertical center of the eye image is searched since the pupil is most dark in the eye image.

The vertical component detecting section 66 detects the vertical component of the edge in the eye image, and outputs it to the filtering section 68. The vertical component detecting section 66 applies Sobel edge detecting method to the eye image to calculate the value of the vertical component of the iris region. The method is to separate the image of bad quality using that the eyelashes is positioned in vertical since it is impossible to recognize the iris when the eyelashes shield the iris.

The filtering section 68 multiplies values F1, F2, and F3 inputted respectively from the blinking detecting section 62, the pupil position detecting section 64, and the vertical component detecting section 66 by the weighted values W1, W2 and W3 respectively. The filtering section 68 excludes the eye image having the value more than the reference value, and outputs the remaining eye image to the iris image extractor 10.

Herein, it is preferable that the weighted value W1 is weighted in proportion to the position of the pupil away from the vertical center of the eye image. For example, when the weighted value 1 is applied to the raw of the vertical center of the eye image, the weighted value 5 is applied to the raw that is four blocks away from the vertical center of the eye image.

It is preferable that the weighted value W2 is weighted in proportion to the position of the pupil away from the center of the eye image, and that the weighted value W3 is weighted regardless of the position of the pupil.

It is possible to determine the quality of the image adapted for recognition by adjusting the reference value applied to the filtering section 68. The result value obtained by multiplying F1, F2, and F3 by W1, W2 and W3 respectively may be used to determine the priority for the image frames obtained for a predetermined time. At this time, it is preferable that the priority is high when in case that the result value is low.

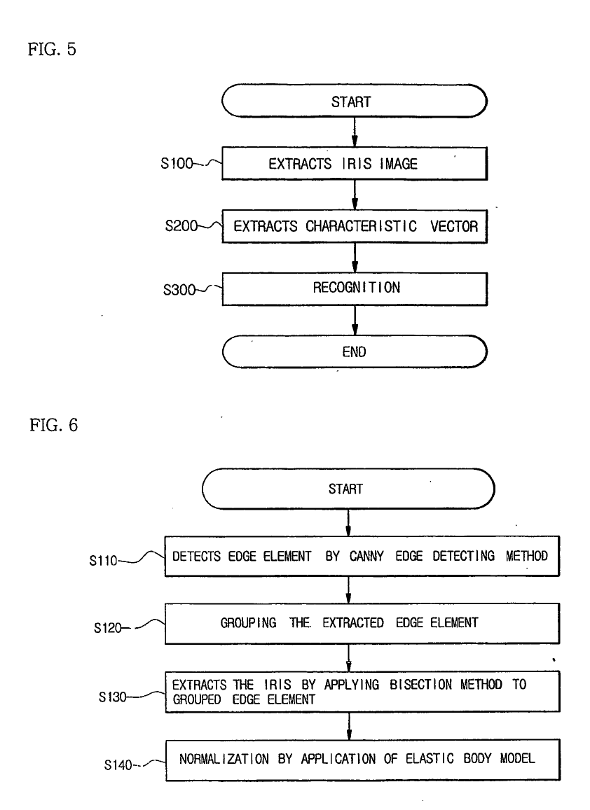

FIG. 5 shows a flow chart of an iris identification method using wavelet-packet transform method. Referring to FIG. 5, the method according to the present invention comprises an iris image extracting step S100, a characteristic vector extracting step S200, and a recognizing step S300.

In the iris image extracting step S100, the iris image is extracted from the eye image inputted from the outside.

In the characteristic vector extracting step S200, the extracted iris image is wavelet-packet transformed and multi-divided, a iris characteristic region is obtained from the multi-divided image, and a characteristic vector is extracted by a statistical method.

In a recognizing step S300, the extracted characteristic vector is compared with a pre-stored characteristic vector. At this time, it is preferable that Support vector machine method is used.

Also, the iris identification method according to the present invention may be further comprising a registering step of recording the characteristic vector extracted in the characteristic vector extracting step S200.

FIG. 6 is a detailed flow chart of illustrating an iris image extracting process.

Referring to FIG. 6, the iris image extracting step S100 comprises a step S110 of detecting an edge element by applying Canny edge detecting method to the eye image, a step S120 of grouping the detected edge element, a step S130 of extracting the iris image by applying Bisection method to the grouped edge element, and a step S140 of normalizing the extracted iris image by applying Elastic body model to the extracted iris image.

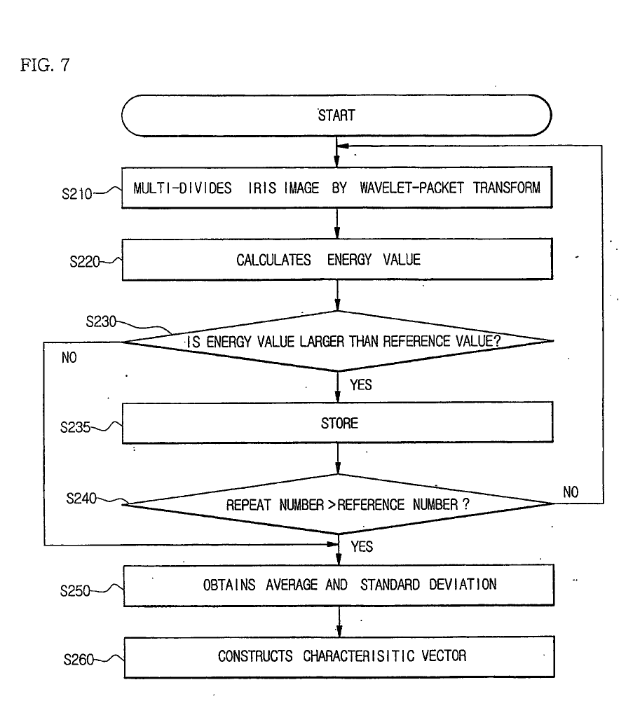

FIG. 7 is a detailed flow chart of illustrating a characteristic vector extracting process.

Referring to FIG. 7, the characteristic vector extracting step S200 comprises a step S210 of wavelet-packet transforming and multi-dividing the iris image extracted in the iris image extracting step, a step S220 of calculating energy value for each region of the multi-divided iris images, a step S230 of comparing energy values of the multi-divided regions with the reference value, a step S235 of extracting and storing regions with energy value more than the reference value, a step S240 of repeating steps S210 to S235 for the extracted regions in a predetermined number, a step 250 of dividing the extracted each region into sub-regions, and obtaining average value and standard deviation value for the sub-regions, and a step S260 of constructing a characteristic vector by using the obtained average value and the standard deviation value.

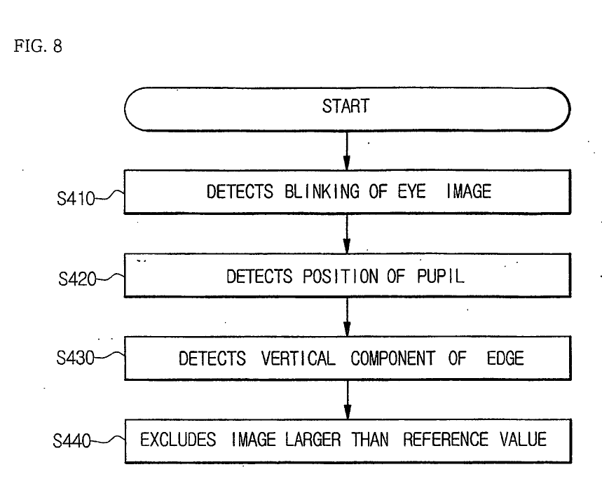

The iris identification method further comprises a video filtering step as shown in FIG. 8. Referring to FIG. 8, the video filtering step S400 comprises a step S410 of detecting a blinking of the eye image, a step S420 of detecting a position of the pupil, a step S430 of detecting the vertical component of edge, and a step S440 of excluding the eye images with values obtained by multiplying values detected in steps S410 to S430 by the weighed values W1, W2, and W3 respectively, and using the remaining eye image. Each obtained value is more than a predetermined value.

Hereinafter, the process comprising steps of extracting the iris image from the eye image, constructing the characteristic vector from the characteristic region extracted by a wavelet packet transform, and comparing the characteristic vector with the pre-stored characteristic vector thereby capable of recognizing the identity for a person is described in detail with reference to FIGS. 1 to 8.

The edge element detecting section 12 of the iris image extractor 20 detecting an edge element by applying Canny edge detecting method to the eye image inputted from the outside (S110). That is, in the step S110, the edge that the difference is generated at foreground and background in the eye image is obtained.

In order to more accurately detect the edge element between pupil 71 and iris 72, and the edge element between sclera 74 and iris 72, the grouping section 14 groups the detected edge elements in a group (S120). The iris image extracting section 16 extracts the iris by applying Bisection method to the grouped edge element as shown in FIG. 2b (S130).

The normalizing section 18 normalizes the extracted iris image by applying Elastic body model as shown in FIG. 2c to the extracted iris image, and outputs it the characteristic vector extracting section 20 (S140).

The multi-dividing section 22 of the characteristic vector extractor 20 wavelet-packet transforms and multi-divides the iris image extracted by the iris image extractor 10 (S210). Thereafter the calculator 24 calculates energy value for each region of the multi-divided iris image (S220).

The characteristic region extracting section 26 compares energy values of the multi-divided regions with the reference value.

Regions with the energy value more than the reference value are extracted and stored (S235), the extracted region repeats steps S210 to S235 in a predetermined number (S240).

As a such, when the iris characteristic region is extracted and stored, the characteristic vector constructing section 28 divides the extracted each region into sub-regions, and obtains average value and standard deviation value (S250). The characteristic vector is constructed by using the average value and standard deviation value.

The recognizer 30 determines identity for a person by applying Support vector machine method to the characteristic vector extracted from the characteristic vector extractor 20 and the characteristic vector stored in the characteristic vector DB 40 (S300).

After calculating distance between the characteristic vectors by applying Support vector machine method to the characteristic vectors, the identity is confirmed in case that the calculated distance is smaller than the reference value.

On the other hand, when the iris identification system further comprises a filtering section 60 as shown in FIG. 4a, the filtering section 60 filters the eye image from the outside, and outputs it to the iris image extractor 10 (S400).

The blinking detecting section 62 calculates sum of average brightness of blocks in each raw, and outputs the brightest value F1 to the filter 60 (S410). The pupil position detecting section 64 calculates block F2 that average brightness is smaller than the predetermined value, and outputs it the filtering section 68 (S420). The vertical component detecting section 66 calculates the value F3 of the vertical component of the iris image by applying Sobel edge detecting method to the eye image (S430).

The filtering section 68 excludes the eye images with the values obtained by multiplying values detected by the blinking detecting section 62, the pupil position detecting section 64 and the vertical component detecting section 66 by the weighed values W1, W2, and W3 respectively (S440) The filtering section 68 outputs the remaining eye image to the iris image extractor 10.

According to the another embodiment of the present invention, the characteristic vector extractor 20 may multi-divide the iris image by using Daubechies wavelet transform, and the recognizer 30 may execute identification by using a normalized Euclidian distance and a minimum distance classification rule.

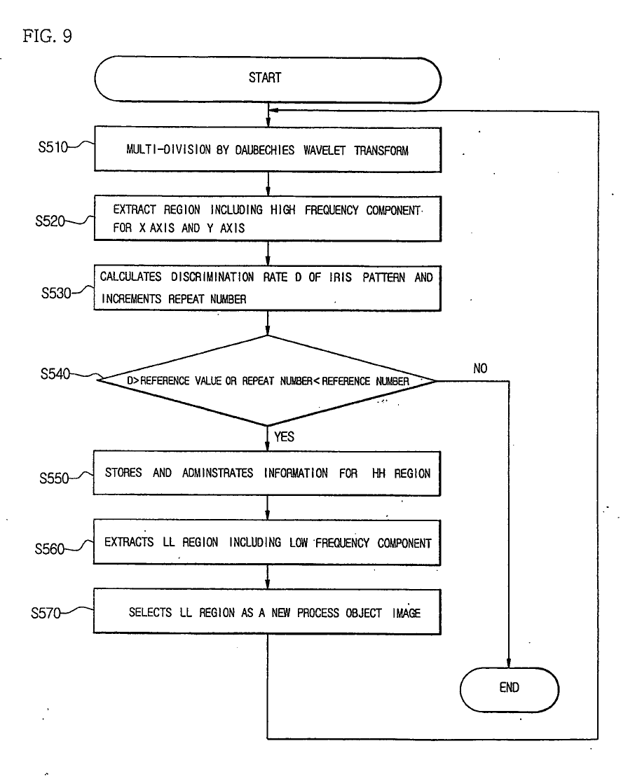

Daubechies wavelet transform is described With reference to FIGS. 3a and 9. FIG. 9 is a flow chart of illustrating an iris identification method using Daubechies wavelet transform.

The multi-dividing section 22 multi-divides the iris image extracted from the iris image extractor 20 by applying Daubechies wavelet transform to the iris image (S510). Also the multi-dividing section 22 extracts the region including the high frequency component HH for the x-axis and y-axis among the multi-divided iris images (S520).

The calculating section 24 calculates the discrimination rate D of the iris pattern according to the characteristic value of the HH region, and increments repeat number (S530).

The characteristic region extractor 26 determines whether the predetermined reference value is smaller than the discrimination rate D or the repeat number is small than the predetermined reference number (S540). As a result, if the reference value is larger than the discrimination rate D or the repeat number is larger than the reference number, the process is completed.

However if the reference value is equal to or smaller than the discrimination rate D, or the repeat number is equal to or smaller than the reference number, the characteristic region extractor 26 stores and administrates the information of HH region at present time (S550).

Next, the characteristic region extracting section 26 extracts LL region including low frequency component for the x-axis and y-axis from the multi-divided iris images (S370), and selects the LL region which is reduced to ¼ size in relation to that of the previous iris image as a new process object.

The iris characteristic region is obtained by repeatedly applying Daubechies wavelet transform to the iris region selected as the new process object.

The discrimination rate D is the value obtained by squaring each pixel value of HH region, and adding the squared values, and dividing the added value by total number of HH region. Whenever the Daubechies wavelet transform is applied, the iris image is divided into HH, HL, LH, and LL regions. FIG. 3b shows that the Daubechies wavelet transform is executed at 3 times.

The characteristic vector constructing section 28 divides the region extracted and stored by the characteristic region extracting section 26 into M×N sub-regions, obtains average value and standard deviation value for each sub-region, and constructs a characteristic vector using the average value and standard deviation value.

As shown in FIG. 3b, since each region is divided into several sub-regions, the characteristic vector is constructed by using the average value and standard deviation value.

The recognizer 60 executes identification for a person by applying normalized Euclidian distance and minimum distance classification rule to the characteristic vector extracted from the characteristic extractor 30 and the characteristic vector stored in the characteristic DB 50.

The recognizer 60 calculates the distance between the characteristic vectors by applying normalized Euclidian distance and minimum distance classification rule.

Since the distance between the characteristic vectors is small, it is preferable that the recognizer 60 determines identity for a person in case that the value obtained by applying minimum distance classification rule to the calculated distance between the characteristic vectors is equal to or smaller than the predetermined reference value.

### INDUSTRIAL APPLICABILITY

As can be seen from the foregoing, the present invention is capable of extracting the iris image without loss of information by using Canny edge detecting method, Bisection method, and Elastic body model.

Also, it is possible to minimize adverse effects due to the pupil movement, and the rotation and position variation of the iris region, the distortion of iris image by the difference between brightness and shade of a camera, and to improve accuracy of iris detection.

It is also possible to improve convenience of user because it is capable of obtaining the iris image regardless of position and distance of the user.

It is possible to construct characteristic vector by effectively extracting the characteristic region including high frequency band as well as low frequency band of the iris image using wavelet packet transform. In particular, it is possible to effectively reduce the size of the characteristic vector because the characteristic vector according to the present invention has a smaller size in comparison with the conventional art.

It is also possible to normalize characteristic vector, and improve discrimination between a person and the other person since Support vector machine method is used as classification rule. Accordingly it is possible to provide an effective system in view of a process performance and process time.

It is also possible to provide an effective system in view of a process performance and process time by executing distance calculation and similarity measurement having not been affected by Euclidian distance or minimum distance classification rule.

It is also possible to provide analysis of the iris pattern information, and to be applied to various pattern recognition fields.

It is also possible to improve effectiveness of process and recognition rate by immediately removing the image in case that the inputted eye image includes blinking, or a portion of the iris is removed because the center of the iris is deviated from the center of the eye image due to the movement of user, or the iris image is obscure due to the shade generated by eyelid, or the iris image includes various shades.

While this invention has been described in connection with what is presently considered to be the most practical and preferred embodiment, it is to be understood that the invention is not limited to the disclosed embodiment and the drawings, but, on the contrary, it is intended to cover various modifications and variations within the spirit and scope of the appended claims.

1. An iris identification system comprising:
a characteristic vector database (DB) for pre-storing characteristic vectors to identify persons;
an iris image extractor for extracting an iris image in the eye image inputted from the outside;
a characteristic vector extractor for multi-dividing the iris image extracted by the iris image extractor, obtaining a iris characteristic region from the multi-divided each iris image, and extracting a characteristic vector from the iris characteristic region by a statistical method; and
a recognizer for comparing the characteristic vector extracted from the characteristic vector extractor with the characteristic vector stored in the characteristic vector DB thereby identifying a person.

2. The iris identification system as claimed in claim 1, wherein the iris image extractor comprises:
an edge element detecting section for detecting edge element by applying Canny edge detection method to the eye image;
a grouping section for grouping the detected edge element;
an iris image extracting section for extracting the iris image by applying Bisection method to the grouped edge element; and
a normalizing section for normalizing the extracted iris image by applying elastic body model to the extracted iris image.

3. The iris identification system as claimed in claim 2, wherein the elastic body model comprises a plurality of elastic bodies, each elastic body is extendible in a longitudinal direction, and has one end connected to sclera and the other end connected to pupil.

4. The iris identification system as claimed in claim 1, wherein the characteristic vector extractor comprises:
a multi-dividing section for wavelet-packet transforming the iris image extracted by the iris image extractor to multi-divide the extracted iris image;
a calculating section for calculating energy values for regions of the multi-divided iris images;
a characteristic region extracting section for extracting and storing the region that has energy value more than a predetermined reference value from the regions of the multi-divided iris images; and
a characteristic vector constructing section for dividing the extracted and stored region into sub-regions, obtaining average value and standard deviation value for the sub-regions, and constructing a characteristic vector by using the average value and the standard deviation value;
for the region extracted from the characteristic region extracting section, the wavelet-packet transform process by the multi-dividing section and the energy value calculating process by the calculating section are repeatedly executed in a determined number, and then the regions having energy value more than the reference value are stored in the characteristic region extracting section.

5. The iris identification system as claimed in claim 4, wherein the calculating section squares the each energy value of the multi-divided region, adds the squared energy values, and divides the added energy value by number of the region thereby capable of obtaining the resultant energy value.

6. The iris identification system as claimed in claim 4, wherein the recognizer calculates the distance between characteristic vectors by applying Support vector machine method to the characteristic vector extracted from the characteristic vector extracting section and the characteristic vector pre-stored in the characteristic vector DB, and confirm the identity for a person if the calculated distance between the characteristic vectors is smaller than the predetermined reference value.

7. The iris identification system as claimed in claim 1, wherein the characteristic vector extractor comprises:
a multi-dividing section for multi-dividing the iris image extracted from the iris image extractor by applying Daubechies wavelet transform to the extracted iris image, and extracting the region including the high frequency component HH for x-axis and y-axis from the multi-divided iris image;
a calculating section for calculating discrimination rate D of the iris pattern by the characteristic value of the HH region, and increments repeat number;
a characteristic region extracting section for determining whether the predetermined reference value is smaller than the discrimination rate D or the repeat number is smaller than the predetermined reference number, completing operation thereof if the reference value is larger than the discrimination rate D or the repeat number is larger than the reference number, storing and administrating the information of HH region if the reference value is equal to or smaller than the discrimination rate D, or the repeat number is equal to or smaller than the reference number, extracting the region LL that has low frequency component for the x-axis and y-axis, selecting the LL region as a new process object image; and
a characteristic vector constructing section for dividing the extracted and stored region into sub-regions, obtaining average value and standard deviation value for the sub-regions, and constructing a characteristic vector by using the average value and the standard deviation value;
for the region selected as the new process object image by the characteristic region extracting section, the multi-dividing process by the multi-dividing section and the processes thereafter are repeatedly executed.

8. The iris identification system as claimed in claim 7, wherein the discrimination rate D is the value obtained by squaring value of the each pixel of HH region, adding the squared values, and dividing the added value by total number of the HH region.

9. The iris identification system as claimed in claim 7, wherein the recognizer confirms the identity for a person by applying the normalized Euclidian distance and Minimum distance classification rule to the characteristic vector extracted from the characteristic vector extractor and the characteristic vector pre-stored in the characteristic vector DB.

10. The iris identification system as claimed in claim 1, wherein the system further comprises a filter for filtering the eye image inputted from the outside, and outputting it to the iris image extractor.

11. The iris identification system as claimed in claim 10, wherein the filter comprises:
a blinking detecting section for detecting a blinking of the eye image;
a pupil position detecting section for the position of the pupil in the eye image;
a vertical component detecting section for detecting the vertical component of the edge;
a filtering section for excluding the eye images that the values obtained by multiplying values detected respectively by the blinking detecting section, the pupil position detector and the vertical component detector by the weighed values W1, W2, and W3 respectively is more than a predetermined reference value, and outputting the remaining eye image to the iris image extractor.

12. The iris identification system as claimed in claim 11, wherein when the eye image is divided into M×N blocks, the blinking detecting means calculates sum of average brightness of blocks in a raw, and outputs the brightest value F1.

13. The iris identification system as claimed in claim 12, wherein the weighted value W1 is weighted in proportion to the distance from the vertical center of the eye image.

14. The iris identification system as claimed in claim 11, wherein when the eye image is divided into M×N blocks, the pupil position detecting section detects the block F2 that the average brightness of each block is smaller than the predetermined value.

15. The iris identification system as claimed in claim 14, wherein the weighted value W2 is weighted in proportional to the distance from the center of the eye image.

16. The iris identification system as claimed in claim 11, wherein the vertical component detecting section detects the value F3 of the vertical component of the iris region by Sobel edge detection method.

17. The iris identification system as claimed in claim 6, wherein the weighted value W3 is the same regardless of the distance from the center of the eye image.

18. The iris identification system as claimed in claim 1, the system further comprises a register to record the characteristic-vector extracted from the characteristic vector extractor in the characteristic vector DB.

19. The iris identification system as claimed in claim 1, the system further comprises a photographing means to take an eye image of a person and to output it to the filter.

20. An iris identification method comprising the steps of:
extracting an iris image in the eye image inputted from the outside;
multi-dividing the extracted iris image, obtaining a iris characteristic region from the multi-divided each iris image, and extracting a characteristic vector from the iris characteristic region by a statistical method; and
comparing the extracted characteristic vector with the characteristic vector stored in the characteristic vector DB thereby identifying a person.

21. The method as claimed in claim 20, wherein the step of extracting the iris image comprises the sub-steps of:
(a1) detecting edge element by applying Canny edge detection method to the eye image;
(a2) grouping the detected edge element;
(a3) extracting the iris image by applying Bisection method to the grouped edge element; and
(a4) normalizing the extracted iris image by applying elastic body model to the extracted iris image.

22. The method as claimed in claim 21, wherein the elastic body model comprises a plurality of elastic bodies, each elastic body is extendible in a longitudinal direction, and has one end connected to sclera and the other end connected to pupil.

23. The method as claimed in claim 20, wherein the step of extracting the characteristic vector comprises the sub-steps of:
(b1) wavelet-packet transforming the iris image extracted by the step (a) to multi-divide the extracted iris image;
(b2) calculating energy values for regions of the multi-divided iris images;
(b3) extracting and storing the region that has energy value more than a predetermined reference value from the regions of the multi-divided iris images, and the wavelet-packet transform step to the energy value calculating step are repeatedly executed for the extracted region; and
(b4) dividing the extracted and stored region into sub-regions, obtaining average value and standard deviation value for the sub-regions, and constructing a characteristic vector by using the average value and the standard deviation value.

24. The method as claimed in claim 23, wherein the energy value is the value obtained by squaring energy values of the multi-divided region, adds the squared energy values, and divides the added energy value by total number of the region.

25. The method as claimed in claim 23, wherein the step of identifying a person comprises the steps of calculating the distance between characteristic vectors by applying Support vector machine method to the extracted characteristic vector and the pre-stored characteristic vector, and confirming the identity for a person if the calculated distance between the characteristic vectors is smaller than the predetermined reference value.

26. The method as claimed in claim 20, wherein the step of extracting the characteristic vector comprises the sub-steps of:
(b1) multi-dividing the iris image extracted from the iris image extractor by applying Daubechies wavelet transform to the extracted iris image;
(b2) extracting the HH region including the high frequency component for x-axis and y-axis from the multi-divided iris image;
(b3) calculating discrimination rate D of the iris pattern by the characteristic value of the HH region, and incrementing repeat number;
(b4) determining whether the predetermined reference value is smaller than the discrimination rate D or the repeat number is smaller than the predetermined reference number;
(b5) completing operation thereof if the reference value is larger than the discrimination rate D or the repeat number is larger than the reference number, and storing and administrating the information of HH region if the reference value is equal to or smaller than the discrimination rate D, or the repeat number is equal to or smaller than the reference number;
(b6) extracting the LL region including low frequency component for the x-axis and y-axis;
(b7) selecting the LL region as a new process object image wherein the multi-dividing step and the steps thereafter are repeatedly executed for the region selected as the new process object image; and
(b8) dividing the extracted and stored region into sub-regions, obtaining average value and standard deviation value for the sub-regions, and constructing a characteristic vector by using the average value and the standard deviation value.

27. The method as claimed in claim 26, wherein the discrimination rate D is the value obtained by squaring value of the each pixel of HH region, adding the squared values, and dividing the added value by total number of the HH region.

28. The method as claimed in claim 26, wherein the step of identifying a person comprises the step of confirming the identity for a person by applying the normalized Euclidian distance and Minimum distance classification rule to the extracted characteristic vector and the pre-stored characteristic vector.

29. The method as claimed in claim 20, further comprises the step of filtering the eye image inputted from the outside.

30. The method as claimed in claim 29, wherein the filtering step comprises the sub-steps of:
(c1) detecting a blinking of the eye image;
(c2) detecting the position of the pupil in the eye image;
(c3) detecting the vertical component of the edge;
(c4) excluding the eye images that the values obtained by multiplying values detected respectively by the blinking detecting, the pupil position detecting and the vertical component detecting steps by the weighed values W1, W2, and W3 respectively is more than a predetermined reference value, and using the remaining eye image.

31. The method as claimed in claim 30, wherein the step (c1) comprises the sub-steps of, when the eye image is divided into M×N blocks, calculating sum of average brightness of blocks in each raw, and outputting the brightest value F1.

32. The method as claimed in claim 31, wherein the weighted value W1 is weighted in proportion to the distance from the vertical center of the eye image.

33. The method as claimed in claim 30, wherein the step (c2) comprises the sub-step of, when the eye image is divided into M×N blocks, detecting the block F2 that the average brightness of each block is smaller than the predetermined value.

34. The method as claimed in claim 14, wherein the weighted value W2 is weighted in proportional to the distance from the center of the eye image.

35. The method as claimed in claim 30, wherein the step (c3) detects the value F3 of the vertical component of the iris region by Sobel edge detection method.

36. The method as claimed in claim 35, wherein the weighted value W3 is the same regardless of the distance from the center of the eye image.

37. The method as claimed in claim 20, the method further comprises the step of recording the extracted characteristic vector.

38. A computer-readable storage medium on which a program is stored, the program including the processes of:
extracting an iris image in the eye image inputted from the outside;
multi-dividing the extracted iris image, obtaining a iris characteristic region from the multi-divided each iris image, and extracting a characteristic vector from the iris characteristic region by a statistical method; and
comparing the extracted characteristic vector with the characteristic vector stored in the characteristic vector DB thereby identifying a person.

39. The storage medium as claimed in claim 38, wherein the process of extracting the iris image comprises the sub-processes of:
(a1) detecting edge element by applying Canny edge detection method to the eye image;
(a2) grouping the detected edge element;
(a3) extracting the iris image by applying Bisection method to the grouped edge element; and
(a4) normalizing the extracted iris image by applying elastic body model to the extracted iris image.

40. The storage medium as claimed in claim 39, wherein the elastic body model comprises a plurality of elastic bodies, each elastic body is extendible in a longitudinal direction, and has one end connected to sclera and the other end connected to pupil.

41. The storage medium as claimed in claim 38, wherein the process of the characteristic vector comprises the sub-processes of:
(b1) wavelet-packet transforming the iris image extracted by the process of extracting the iris image to multi-divide the extracted iris image;
(b2) calculating energy values for regions of the multi-divided iris images;
(b3) extracting and storing the region that has energy value more than a predetermined reference value from the regions of the multi-divided iris images, and the wavelet-packet transform process to the energy value calculating process are repeatedly executed for the extracted region; and
(b4) dividing the extracted and stored region into sub-regions, obtaining average value and standard deviation value for the sub-regions, and constructing a characteristic vector by using the average value and the standard deviation value.

42. The storage medium as claimed in claim 41, wherein the energy value is the value obtained by squaring energy values of the multi-divided region, adds the squared energy values, and divides the added energy value by total number of the region.

43. The storage medium as claimed in claim 41, wherein the process of identifying a person comprises the sub-processes of calculating the distance between characteristic vectors by applying Support vector machine method to the extracted characteristic vector and the pre-stored characteristic vector, and confirming the identity for a person if the calculated distance between the characteristic vectors is smaller than the predetermined reference value.

44. The storage medium as claimed in claim 38, wherein the process of extracting the characteristic vector comprises the sub-processes of:
(b1) multi-dividing the iris image extracted from the iris image extractor by applying Daubechies wavelet transform to the extracted iris image;
(b2) extracting the HH region including the high frequency component for x-axis and y-axis from the multi-divided iris image;
(b3) calculating discrimination rate D of the iris pattern by the characteristic value of the HH region, and incrementing repeat number;
(b4) determining whether the predetermined reference value is smaller than the discrimination rate D or the repeat number is smaller than the predetermined reference number;
(b5) completing operation thereof if the reference value is larger than the discrimination rate D or the repeat number is larger than the reference number, and storing and administrating the information of HH region if the reference value is equal to or smaller than the discrimination rate D, or the repeat number is equal to or smaller than the reference number;
(b6) extracting the LL region including low frequency component for the x-axis and y-axis;
(b7) selecting the LL region as a new process object image wherein the multi-dividing process and the processes thereafter are repeatedly executed for the region selected as the new process object image; and
(b8) dividing the extracted and stored region into sub-regions, obtaining average value and standard deviation value for the sub-regions, and constructing a characteristic vector by using the average value and the standard deviation value.

45. The storage medium as claimed in claim 44, wherein the discrimination rate D is the value obtained by squaring value of the each pixel of HH region, adding the squared values, and dividing the added value by total number of the HH region.

46. The storage medium as claimed in claim 44, wherein the process of identifying a person comprises the process of confirming the identity for a person by applying the normalized Euclidian distance and Minimum distance classification rule to the extracted characteristic vector and the pre-stored characteristic vector.

47. The storage medium as claimed in claim 38, further comprises the process of filtering the eye image inputted from the outside.

48. The storage medium as claimed in claim 47, wherein the filtering process comprises the sub-processes of:
(c1) detecting a blinking of the eye image;
(c2) detecting the position of the pupil in the eye image;
(c3) detecting the vertical component of the edge;
(c4) excluding the eye images that the values obtained by multiplying values detected respectively by the blinking detecting process, the pupil position detecting process and the vertical component detecting process by the weighed values W1, W2, and W3 respectively is more than a predetermined reference value, and using the remaining eye image.

49. The storage medium as claimed in claim 48, wherein the process (c1) comprises the sub-processes of, when the eye image is divided into M×N blocks, calculating sum of average brightness of blocks in each raw, and outputting the brightest value F1.

50. The storage medium as claimed in claim 49, wherein the weighted value W1 is weighted in proportion to the distance from the vertical center of the eye image.

51. The storage medium as claimed in claim 51, wherein the process (c2) comprises the sub-process of, when the eye image is divided into M×N blocks, detecting the block F2 that the average brightness of each block is smaller than the predetermined value.

52. The storage medium as claimed in claim 51, wherein the weighted value W2 is weighted in proportional to the distance from the center of the eye image.

53. The storage medium as claimed in claim 48, wherein the process (c3) detects the value F3 of the vertical component of the iris region by Sobel edge detection method.

54. The storage medium as claimed in claim 53, wherein the weighted value W3 is the same regardless of the distance from the center of the eye image.

55. The storage medium as claimed in claim 38, the program further comprises the process of recording the extracted characteristic vector.
